(19) United States
(12) Patent Application Publication
(10) Pub. No.: US 2008/0270556 A1
(43) Pub. Date: Oct. 30, 2008

(54) Contact-based communication threading system

(76) Inventors: Drew Bamford, Tao-Yuan City (TW); Martijn Van Tilburg, Tao-Yuan City (TW); Rob Girling, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 12/051,855

(22) Filed: Mar. 20, 2008

Related U.S. Application Data
(60) Provisional application No. 60/914,768, filed on Apr. 30, 2007.

(51) Int. Cl. G06F 15/82

(52) U.S. Cl. 709/206

(57) ABSTRACT

A method of displaying messages received from or sent to communication devices includes displaying a list of all communication devices from which at least one stored message has been received or to which at least one stored message has been sent, selecting a communication device from the list of communication devices, displaying a list of stored messages received from and sent to the selected communication device.

### CROSS REFERENCE TO RELATED APPLICATIONS

This application claims the benefit of the filing date of U.S. provisional patent application No. 60/914,768, filed Apr. 30, 2007, the contents of which are hereby incorporated by reference.

### BACKGROUND OF THE INVENTION

1. Field of the Invention

The invention relates to a portable messaging device, and more particularly, to a portable messaging device that makes use of a contact-based communication threading system for organizing messages sent to and received from other communication devices.

2. Description of the Prior Art

With the ever increasing amount of communication devices coming into the market, such as computers, personal digital assistants (PDAs), mobile phones, and smart phones, the need to organize sent and received messages becomes an important goal for users as well as product manufacturers. In the past, many different organization schemes for organizing sent and received messages have been used.

Please refer to FIGS. 1 and 2. FIG. 1 shows an email inbox 10 according to the prior art. The email inbox 10 shown is a screenshot from the Gmail™ webmail service. The email inbox 10 shows a listing of email messages received from various senders. FIG. 2 illustrates the threaded message view 20 that the Gmail™ webmail service makes use of. When an email is selected for viewing, all related messages that have been sent to other users or received from other users are also shown in the threaded message view 20. The threaded message view 20 makes it easy for users of the Gmail™ webmail service to view related messages quickly and easily.

Please refer to FIGS. 3 and 4. FIG. 3 is a message inbox 30 according to the prior art. The message inbox 30 illustrates the organization method for sent and received messages in a Treo™ 750 smartphone. As shown in FIG. 3, the message inbox 30 contains one message 32. When the message 32 is selected, all related messages are displayed in screen 40 as shown in FIG. 4. Screen 40 shows message 32 along with related message 42. Message 32 was received from a user named “Rob”, whereas related message 42 was sent to “Rob”.

Please refer to FIGS. 5 and 6. FIG. 5 is a message inbox 50 according to the prior art. The message inbox 50 illustrates the organization method for sent and received messages in a Treo™ 650 smartphone. As shown in FIG. 5, the message inbox 50 contains one message 52. When the message 52 is selected, all related messages are displayed in screen 60 as shown in FIG. 6. Screen 60 shows message 52 along with related messages 62, 64, and 66. Messages 52 and 64 were received from a user named “Lisa”, whereas messages 62 and 66 were sent to “Lisa”.

In all of the examples shown above in FIGS. 1-6, only one type of message is shown in the listing of related messages. FIGS. 1 and 2 show subject-based organization, in which the listing of email messages are related according to the subject of the message. FIGS. 3 and 4 as well as FIGS. 5 and 6 show contact-based organization, in which the listing of instant messages are related according to the contact person that the messages are being sent to and received from. Although the above organization methods make it easier to find messages, each of these methods is limited to displaying a single type of message at a time.

### SUMMARY OF THE INVENTION

It is therefore one of the primary objectives of the claimed invention to provide a contact-based communication threading system for organizing many different types of messages sent to and received from respective contacts.

According to an exemplary embodiment of the claimed invention, a method of displaying messages received from or sent to communication devices is disclosed. The method includes displaying a list of all communication devices from which at least one stored message has been received or to which at least one stored message has been sent, selecting a communication device from the list of communication devices, displaying a list of stored messages received from and sent to the selected communication device.

According to another exemplary embodiment of the claimed invention, a method of organizing messages received from or sent to communication devices is disclosed. The method includes receiving or sending a first message from/to a selected communication device, the first message being of a first message type, receiving or sending a second message from/to the selected communication device, the second message being of a second message type, presenting the first message and the second message in a list of stored messages received from or sent to the selected communication device.

According to yet another exemplary embodiment of the claimed invention, a portable messaging device for sending messages to or receiving messages from communication devices is disclosed. The portable messaging device includes a memory for storing sent or received messages and a display for displaying a list of all communication devices from which at least one stored message has been received or to which at least one stored message has been sent. The portable messaging device also contains a control element for selecting a communication device from the list of communication devices and a processor for controlling the display to display a list of stored messages received from and sent to the selected communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an email inbox according to the prior art.

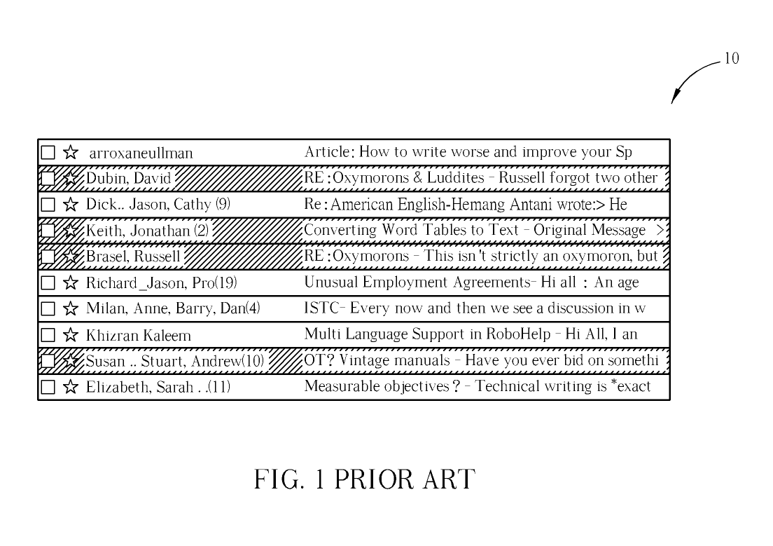

FIG. 2 illustrates the threaded message view that the Gmail T webmail service makes use of.

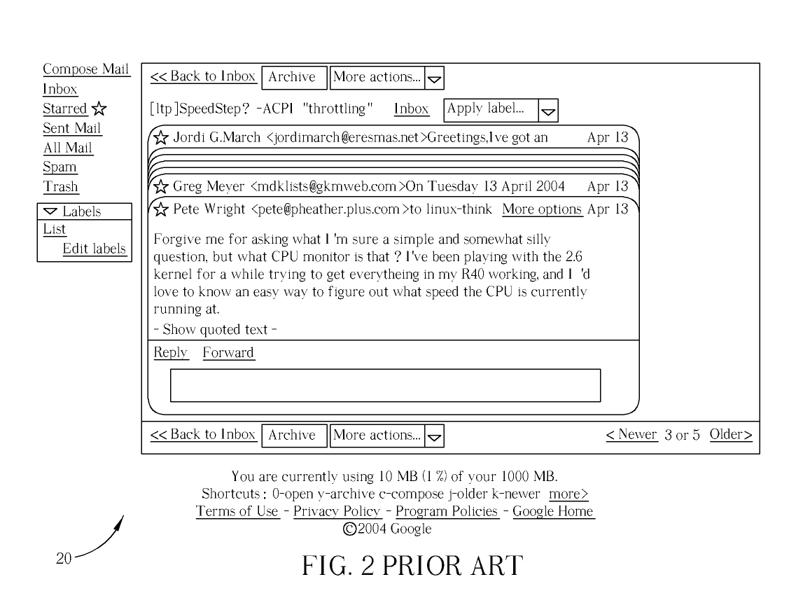

FIG. 3 is a message inbox according to the prior art.

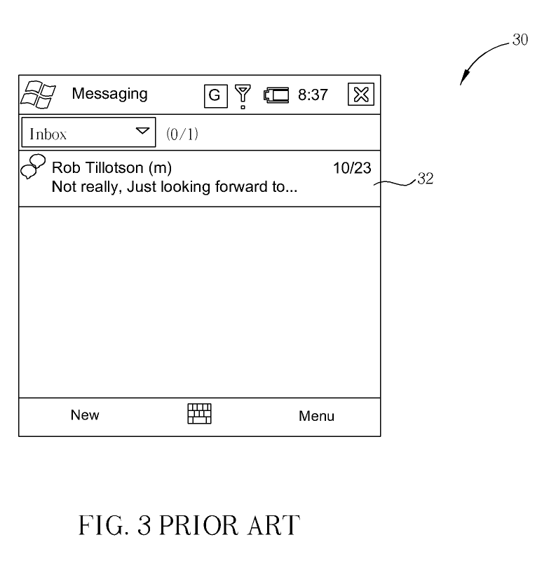

FIG. 4 shows the grouping of related messages according to the prior art.

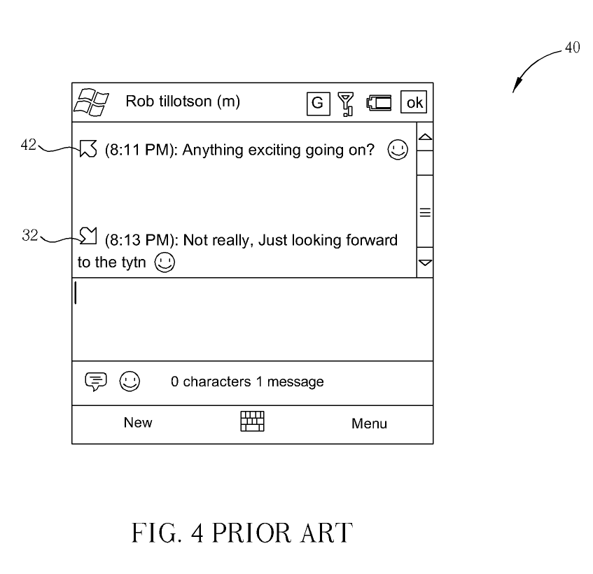

FIG. 5 is another message inbox according to the prior art.

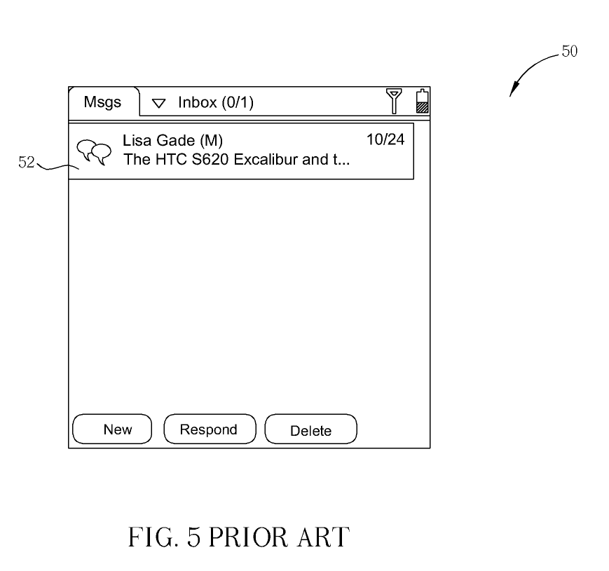

FIG. 6 shows the grouping of related messages according to the prior art.

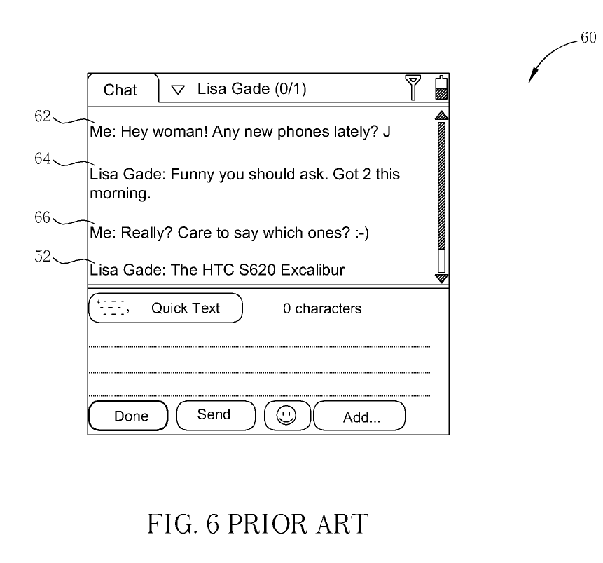

FIG. 7 is a functional block diagram of a portable messaging device according to the present invention.

FIG. 8 illustrates a listing of contacts for which sent messages or received messages are stored according to the present invention.

FIG. 9 is a listing of stored messages that were sent to or received from a contact.

FIG. 10 is a listing of contact details for a selected contact.

FIG. 11 shows a listing of messages sent to and received from the selected contact.

FIG. 12 shows a screen showing what song the selected contact is currently listening to and what songs are in the selected contact's shared playlists.

### DETAILED DESCRIPTION

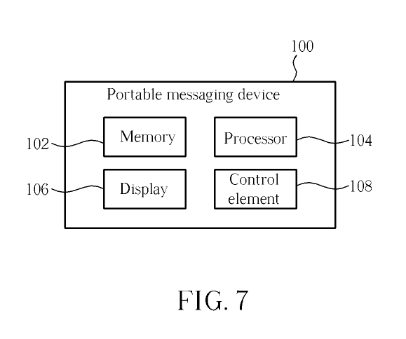

Please refer to FIG. 7. FIG. 7 is a functional block diagram of a portable messaging device 100 according to the present invention. The portable messaging device 100 may be any portable electronic device that is capable of sending and receiving more than one type of message. Examples of different messages that can be sent and received are Short Message Service (SMS) messages, Multimedia Messaging Service (MMS) messages, Instant Message (IM) type messages, voicemail messages, and email messages. The portable messaging device 100 may be a personal digital assistant (PDA), a smart phone, a computer, or any such device.

FIG. 7 shows the portable messaging device 100 having a memory 102, a processor 104, a display 106, and a control element 108. The portable messaging device 100 may also contain other components, and the embodiment shown in FIG. 7 is not meant to limit the present invention. The memory 102 is used to store messages that have been sent to and received from one or more contacts. The processor 104 is used for controlling operation of the portable messaging device 100 and for controlling the display 106 to display selected messages or listings of messages. The control element 108 are used as part of a user interface for allowing the user of the portable messaging device 100 to navigate through menus of the portable messaging device 100 and for selecting chosen contacts and messages. The control element contains at least a control button for inputting control commands.

The main idea of the present invention is to provide a contact-based message threading system for displaying all sent and received messages in a single view. The present invention avoids separating message of different types into different views, such as one view for instant messages, another view for email messages, and another view for voice mail messages. Instead, all supported message types are listed in a single view according to the contact that the messages were received from or sent to.

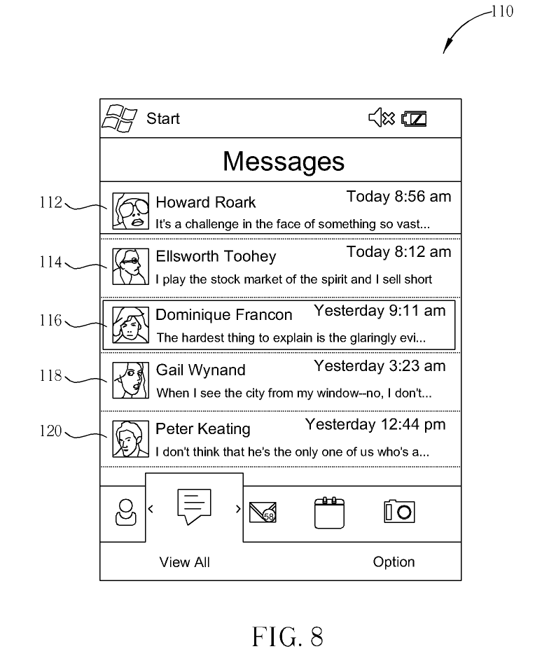

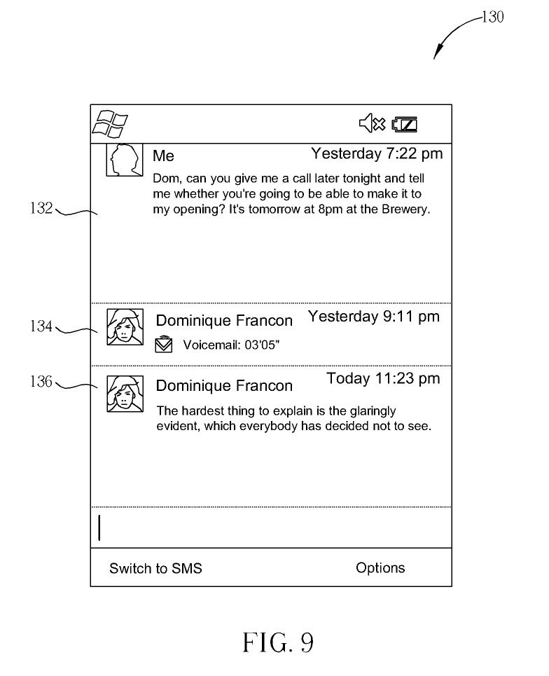

Please refer to FIG. 8. FIG. 8 illustrates a listing of contacts 110 for which sent messages or received messages are stored according to the present invention. As shown, stored messages have been sent to and/or received from contacts 112, 114, 116, 118, and 120. The user of the portable messaging device 100 may use the control element 108, such as a control button for selecting one of the contacts from the listing of contacts 110. In this example, contact 116 is selected, and the user is presented with the screen shown in FIG. 9. FIG. 9 is a listing of stored messages 130 that were sent to or received from contact 116, whose name is “Dominique”. The listing of stored messages 130 contains message 132 that was sent from the user of the portable messaging device 100 (labeled as “Me”) to Dominique. The message 132 may be an instant message, an email message, or any other similar type of text message. Next is message 134, which is a voice mail message received from Dominique, followed by another message 136 received from Dominique. The messages shown in the listing of stored messages 130 may be sorted according to chronological order, reverse chronological order, or another suitable sorting order.

Alternatively, instead of listing messages sent to and received from specific contact persons, the present invention can also list messages according to the communication devices that they were sent to and received from. In either case, the present invention utilizes the contact-based message threading system to list two or more types of messages on the same screen.

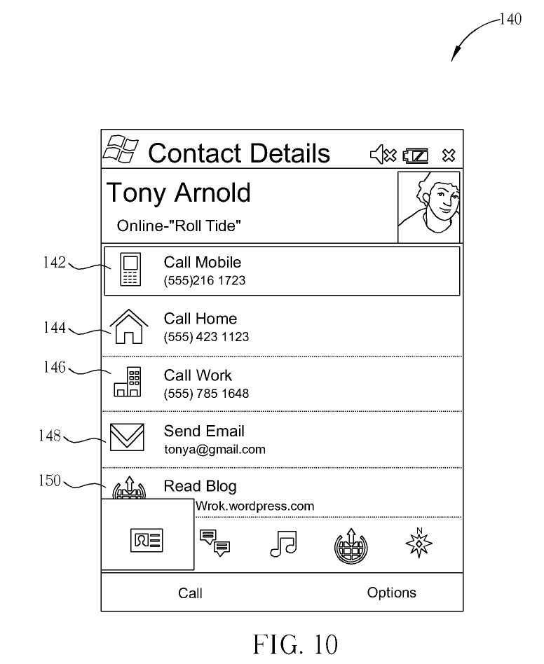

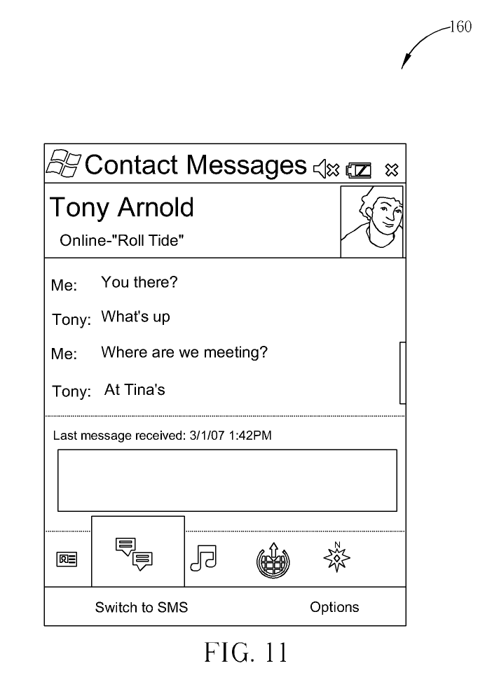

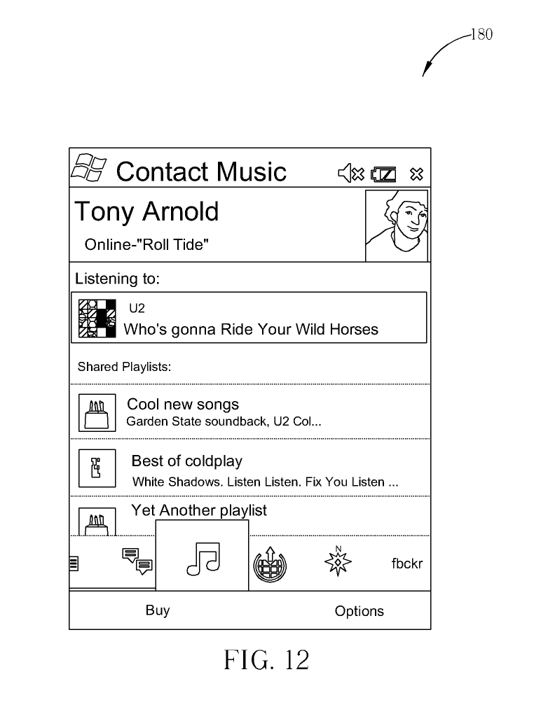

In addition to listing messages received from or sent to a contact, other details about the contact can also be displayed. Please refer to FIGS. 10-12. FIG. 10 is a listing of contact details 140 for a selected contact named “Tony”. In the listing of contact details 140, the user is presented with an option 142 for calling Tony's mobile phone, an option 144 for calling Tony's home phone, an option 146 for calling Tony's work phone, an option 148 for sending an email to Tony, and an option 150 for reading Tony's blog. FIG. 11 shows a listing of messages 160 sent to and received from Tony, while FIG. 12 shows a screen 180 showing what song Tony is currently listening to and what songs are in Tony's shared playlists.

In summary, the present invention provides a contact-based, or communication device-based, message threading system for displaying more than one type of message in a single listing of sent and received messages. In this way, a complete history of messages sent to and received from a specific contact person or communication device can be readily seen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying messages received from or sent to communication devices, the method comprising:
displaying a list of all communication devices from which at least one stored message has been received or to which at least one stored message has been sent;
selecting a communication device from the list of communication devices; and
displaying a list of stored messages received from and sent to the selected communication device.

2. The method of claim 1, wherein the list of stored messages received from and sent to the selected communication device is sorted in chronological order.

3. The method of claim 1, wherein the list of stored messages received from and sent to the selected communication device is sorted in reverse chronological order.

4. The method of claim 1, wherein the list of stored messages contains messages of two or more message types.

5. The method of claim 4, wherein the list of stored messages contains a Short Message Service (SMS) message.

6. The method of claim 4, wherein the list of stored messages contains a Multimedia Messaging Service (MMS) message.

7. The method of claim 4, wherein the list of stored messages contains an Instant Message (IM) type message.

8. The method of claim 4, wherein the list of stored messages contains a voicemail message.

9. The method of claim 4, wherein the list of stored messages contains an email message.

10. The method of claim 1, further comprising:
choosing a selected message to view from the list of stored messages received from and sent to the selected communication device; and
viewing the selected message.

11. The method of claim 1, wherein the communication devices contains contact information corresponding to the communication devices.

12. A method of organizing messages received from or sent to communication devices, the method comprising:
receiving or sending a first message from/to a selected communication device, the first message being of a first message type;
receiving or sending a second message from/to the selected communication device, the second message being of a second message type; and
presenting the first message and the second message in a list of stored messages received from or sent to the selected communication device.

13. The method of claim 12, wherein the list of stored messages received from and sent to the selected communication device is sorted in chronological order.

14. The method of claim 12, wherein the list of stored messages received from and sent to the selected communication device is sorted in reverse chronological order.

15. The method of claim 12, wherein the list of stored messages contains a Short Message Service (SMS) message.

16. The method of claim 12, wherein the list of stored messages contains a Multimedia Messaging Service (MMS) message.

17. The method of claim 12, wherein the list of stored messages contains an Instant Message (IM) type message.

18. The method of claim 12, wherein the list of stored messages contains a voicemail message.

19. A portable messaging device for sending messages to or receiving messages from communication devices, the portable messaging device comprising:
a memory for storing sent or received messages;
a display for displaying a list of all communication devices from which at least one stored message has been received or to which at least one stored message has been sent;
a control element for selecting a communication device from the list of communication devices; and
a processor for controlling the display to display a list of stored messages received from and sent to the selected communication device.

20. The device of claim 19, wherein the processor sorts the list of stored messages received from and sent to the selected communication device in chronological order.

21. The device of claim 19, wherein the processor sorts the list of stored messages received from and sent to the selected communication device in reverse chronological order.

22. The device of claim 19, wherein the list of stored messages contains messages of two or more message types.

23. The device of claim 19, wherein the control element is used for choosing a selected message to view from the list of stored messages received from and sent to the selected communication device.

24. The device of claim 19, wherein the communication devices contains contact information corresponding to the communication devices.

25. The device of claim 19, wherein the control element contains a control button.
